(19) United States
(12) Patent Application Publication
(10) Pub. No.: US 2009/0215999 A1
(43) Pub. Date: Aug. 27, 2009

(54) Preparation Of Organosilicon Compounds In Two-Phase Medium

(75) Inventor: Sebastien Sterin, Saint Cyr Au Mont D'Or (FR)

Correspondence Address: BUCHANAN, INGERSOLL & ROONEY PC, POST OFFICE BOX 1404, ALEXANDRIA, VA, 22313-1404, US

(73) Assignee: RHODIA CHIMIE, Aubervilliers (FR)

(21) Appl. No.: 11/921,010

(22) PCT Filed: May 17, 2006
(86) PCT No.: PCT/FR2006/001108

§ 371 Date: Apr. 9, 2009

(30) Foreign Application Priority Data
May 26, 2005 (FR) 05 05285

(51) Int. Cl. C07F 7/02

(52) U.S. Cl. 534/578

(57) ABSTRACT

Thermally stable functionalized organosilicon compounds containing at least one activated azo group, of formula (I): [(G⁰)₃SiO_{1/2}]ₘ[(G⁰)₂SiO_{2/2}]ₙ[G⁰SiO_{3/2}]ₒ[SiO_{4/2}]ₚ[(G²)ₐ(G¹)_{a′}(Z-CO—HN═NH—CO-A)SiO_{(3-a-a′)/2}] are synthesized from at least one hydrazino precursor (II) (—HN—NH—) of the compound (I), oxidizing the precursor (II) into an azo group for the compound (I), employing an oxidizing system including at least one oxidizing agent (Ox) and at least one base (B), such oxidizing being carried out in a two-phase aqueous/organic medium and such that the pH of the aqueous phase ranges from 3 to 11.

The field of the invention is the synthesis of functionalized organosilicon compounds.

The invention relates more particularly to organosilicon compounds comprising at least one activated azo group. Said activation can result, for example, from the presence of carbonyl groups near the nitrogens. The organosilicon moiety of these compounds can comprise for example hydrolyzable or condensable groups of type ≡SiOR or ≡SiOH.

Such organosilicon compounds with available activated azo group(s) (for example those with the group —CO—N═N—CO—) are very useful, notably in the synthesis of organic active molecules (for example nitrogen-containing heterocycles) for use in the areas of agrochemistry and pharmacy, for example as dienophiles in a hetero-Diels-Alder reaction.

However, few of these compounds are available, in particular because they are difficult to prepare. It would therefore be desirable to be able to extend the range of organosilicon compounds that are available.

In the sparse prior art, we find patent application FR-A-2340323, which discloses organosilicon compounds of formula (I*):

Y—X—CO—N═N—CO—X¹-Z*

In which X and X¹, which may be identical or different, each represent an imino group, an oxygen atom or a substituted or unsubstituted methylene group; Y is a substituted or unsubstituted alkyl, aryl or aralkyl group, or is identical to Z*; Z* is an alkyl, aryl or aralkyl group with, as substituent, at least one silane group of formula Si(OR)₃ or OSi(OR)₃ in which R is a linear or branched alkyl group, preferably with 1 to 6 carbon atoms.

Organosilicon compounds of formula (II*) and (III*):

R¹*—O—CO—N═N—CO—NH—(C₆H₆)—(CH₂)ₘSi(OR²*)₃ (II*)

R¹*—O—CO—N═N—CO—NH—(CH₂)ₙ—Si(OR²*)₃ (III*)

in which R¹* and R²*, which may be identical or different, each represent a linear or branched alkyl group preferably containing between 1 and 6 carbon atoms, m is equal to 0, 1, 2 or 3 and n is equal to 1, 2 or 3, are mentioned.

An organosilicon compound with azo groups of formula Ethyl-O—CO—N═N—CO—NH— (CH₂)₃—Si (OEthyl)₃, according to formula (III*), is disclosed in example 3.

The key stage in the synthesis of organosilicon compounds of this type with an activated azo group comprises the oxidation of a function of the hydrazo (NH—NH) type to a corresponding azo (N═N) function.

According to FR-A-2340323, this transformation is carried out by means of an oxidizing system comprising an oxidizing agent formed by a halogenated derivative (chlorine, bromine, N-bromosuccinimide among other examples) and a base of the pyridine type.

Thus, the method described in example 3 of FR-A-2340323 envisages the application of an organic solution of precursor Ethyl-O—CO—HN—NH—CO—NH—(CH₂)₃—Si(OEthyl)₃ and of pyridine, in dichloromethane. N-Bromosuccinimide (NBS) is added to this solution which is stirred for 2 hours after adding NBS. The solvent and the pyridine are removed by evaporation under vacuum, whereas the solid salts formed during the reaction are then removed by filtration. After washing the residue, the organosilicon compound with azo groups of formula (III*) is recovered in the filtrate. According to this document, the oxidizing system NBS-pyridine is used in excess (10 mol. %) relative to the precursor.

This synthesis is carried out in an organic medium in rigorously anhydrous conditions. Now, it is often difficult and restricting to obtain and maintain rigorously anhydrous operating conditions on an industrial scale. The use of solid NBS and the filtration stage are disadvantageous operational factors in an industrial process. Moreover, it is known that in the presence of water, the functional alkoxysilanes are liable to undergo reactions of hydrolysis and condensation, leading to the formation of macromolecular structures. These reactions of hydrolysis and condensation depend on several parameters: nature of the alkoxy groups, nature of the functions other than alkoxy grafted on the silicon, pH of the water, etc. To preserve optimal application properties, it is preferable if the formation of oligomers by hydrolysis/condensation is limited to the maximum possible extent.

Moreover, this known method requires improvement in terms of yield, productivity and cost. Finally, the final product is not pure. It contains residues that are undesirable and troublesome, notably in terms of industrial hygiene and ecotoxicity on the one hand, and in terms of performance in, applications on the other hand.

Against this background, one of the main aims of the present invention is to propose an improved method of preparation of organosilicon compounds with azo group(s), by oxidation of the hydrazino group of a precursor to an azo group, said method offering a means of access to compounds of interest, avoiding the use of rigorously anhydrous operating conditions and/or the filtration stage for separating the salts generated by the reaction.

Another essential aim of the invention is to provide a method of preparation of organosilicon compounds with azo group(s), which are more stable, notably at high temperatures, for example between 80 and 180° C. (stability determined by differential scanning calorimetry, DSC).

Another essential aim of the invention is to provide a method of preparation of organosilicon compounds with azo group(s), which have better performance than those disclosed in the prior art, notably in terms of productivity and yield of target azoalkoxysilane.

Another essential aim of the present invention is to provide an economical method of preparation of organosilicon compounds with azo group(s).

Another essential aim of the invention is to provide a method of preparation of organosilicon compounds with azo group(s), which permits the quality of the final product to be optimized, notably with respect to the purity of said compounds, and especially by reducing to trace levels, or even completely eliminating, undesirable residues, in particular in connection with the performance required in applications and industrial and environmental hygiene.

These aims, among others, are achieved by the invention, which relates, firstly, to a method of preparation of organosilicon compounds comprising one or more compounds, which may be identical to or different from one another, of formula (I) specified below:

[(G⁰)₃SiO_{1/2}]ₘ[(G⁰)₂SiO_{2/2}]ₙ[G⁰SiO_{3/2}]ₒ[SiO_{4/2}]ₚ[(G²)ₐ(G¹)_{a′}(Z-CO—N═N—CO-A)SiO_{(3-a-a′)/2}]_{q} (I)

in which:
m, n, o, p each represent an integer or fraction greater than or equal to 0;
q represents an integer or fraction greater than or equal to 1;
a represents an integer selected from 0, 1, 2 and 3;
a′ represents an integer selected from 0, 1 and 2;
the sum a+a′ is in the range from 0 to 3 with conditions according to which:
   -(C1)- when a=0, then:
      either at least one of m, n, o, p is a number different from 0 (zero) and q is greater than or equal to 1;
      or q is greater than 1 and each of m, n, o, p has any value;
      and at least one of the symbols G⁰ corresponds to the definition given hereunder for G²;
-(C2)- and when a+a′=3, then m=n=o=p=0 (zero);
the symbols G⁰, which may be identical or different, each represent one of the groups corresponding to G² or G¹;
the symbols G², which may be identical or different, each represent: a hydroxyl group, a hydrolyzable monovalent group or two G² form together, and with the silicon to which they are attached, a ring having 3 to 5 hydrocarbon ring members and which can contain at least one heteroatom, and at least one of these ring members can also be a ring member of at least one other hydrocarbon or aromatic ring;
the symbols G¹, which may be identical or different, each represent: a saturated or unsaturated aliphatic hydrocarbon group; a saturated or unsaturated and/or aromatic, monocyclic or polycyclic, carbocyclic group; or a group representing a saturated or unsaturated, aliphatic hydrocarbon moiety and a carbocyclic moiety as defined above;
the symbol Z represents a divalent radical selected from: a saturated or unsaturated aliphatic hydrocarbon group; a saturated, unsaturated and/or aromatic, monocyclic or polycyclic, carbocyclic group; and a group having a saturated or unsaturated, aliphatic hydrocarbon moiety and a carbocyclic moiety as defined above; said divalent radical being optionally substituted or interrupted by an oxygen atom and/or a sulfur atom and/or a nitrogen atom, said nitrogen atom bearing 1 monovalent group selected from: a hydrogen atom; an aliphatic, saturated or unsaturated hydrocarbon atom; a saturated or unsaturated and/or aromatic, monocyclic or polycyclic, carbocyclic group; and a group having a saturated or unsaturated, aliphatic hydrocarbon moiety and a carbocyclic moiety as defined above;
the symbol A represents:
   a saturated or unsaturated aliphatic hydrocarbon group; a saturated or unsaturated and/or aromatic, monocyclic or polycyclic, carbocyclic group; or a group representing a saturated or unsaturated, aliphatic hydrocarbon moiety and a carbocyclic moiety as defined above;

a group —X-G³ where: X represents —O—, —S— or —NG⁴- with G⁴ taking any one of the meanings given previously for G¹; G³, identical to or different from G⁴, represents any one of the groups defined for G¹; and the substituents G³ and G⁴ of the group —NG⁴G³ can, in addition, form together, and with the nitrogen atom to which they are attached, a single ring having from 5 to 7 ring members, with the ring containing 3 to 6 carbon atoms, 1 or 2 nitrogen atom(s) and optionally 1 or 2 unsaturated double bond(s);

or, when q=1, a group 1-Z-SiO_{(3-a-a′)/2}(G²)ₐ(G¹)_{a′}][(G⁰)₃SiO_{1/2}]ₘ[(G⁰)₂SiO_{2/2}]ₙ[G⁰SiO_{3/2}]ₒ[SiO_{4/2}]ₚ in which the symbols Z, G¹, G², a, a′, m, n, o, and p have the definitions stated previously;
this method being of the type of those comprising:
   employing at least one precursor (II) of at least one organosilicon compound (I), said precursor corresponding to the following formula (II):

[(G⁰)₃SiO_{1/2}]ₘ[(G⁰)₂SiO_{2/2}]ₙ[G⁰SiO_{3/2}]ₒ[SiO_{4/2}]ₚ[(G²)ₐ(G¹)_{a′}(Z-CO—HN—NH—CO-A)SiO_{(3-a-a′)/2}] (II)
in which the symbols G⁰, G¹, G², Z, A, m, n, o, p, a, a′ and q are as defined above under formula (I),
oxidizing the hydrazino group of precursor (II) to an azo group belonging to the organosilicon compound with activated azo group(s) (I), by means of an oxidizing system comprising at least one oxidizing agent (Ox) and at least one base (B),
and, in the case when condition -(C1)- applies, employing an additional reagent selected from the silanes (used alone or mixed together) of formula (III):

(G⁰)₄₋ₚ₁Si(G^{2′})ₚ₁
in which:
   the symbols G⁰, which may be identical or different, each represent: a saturated or unsaturated aliphatic hydrocarbon group; a saturated or unsaturated and/or aromatic, monocyclic or polycyclic, carbocyclic group; or a group representing a saturated or unsaturated, aliphatic hydrocarbon moiety and a carbocyclic moiety as defined above; or a polysiloxane residue;
   the symbols G², which may be identical or different, represent a hydrolyzable monovalent group corresponding to the same definition as that given above for the symbols G² described in connection with formula (I);
   p1 represents an integer selected from 1 and 2, preferably 1;

and this method being characterized in that oxidation is carried out in an aqueous/organic two-phase medium and in such a way that the pH of the aqueous phase is between 3 and 11, preferably between 5 and 9.

This method involves working in a water/organic solvent two-phase medium. The transformation of precursors (II) to organosilicon compounds with activated azo group(s) (I) is effected in the organic phase, whereas the aqueous phase dissolves the various water-soluble compounds generated by the transformation.

Moreover, ionic compounds, and notably acids, are known to have particularly good solubility in an aqueous phase. It is thus preferable, according to the invention, if the method to which it relates envisages the use of an aqueous phase whose pH stays between 3 and 11 throughout the reaction, and preferably between 5 and 9. For example, it could be advantageous to use an aqueous solution whose pH remained close to neutral (pH≈7) throughout the reaction.

The method according to the invention is an improvement on the prior art in that it removes the onerous industrial constraints connected with the use of anhydrous conditions and/or a filtration stage and/or a solid reagent.

Furthermore, it makes it possible to control side reactions of hydrolysis/condensation. Notably this limits the formation of oligomers and makes it possible to preserve the optimal application properties for the target organosilicon compounds with activated azo group(s) (I).

Moreover, said compounds (I) obtained by the method according to the invention are remarkably pure. In particular, these compounds contain little or no (undetectable traces) undesirable residues, such as pyridine residues.

Without wishing to be bound to a theory, it is possible that this purity is at the origin of the excellent stability found for said compounds (I) resulting from the two-phase method according to the invention. By “stability”, we mean notably stability in storage, especially in humid conditions, but in particular stability when heated.

One of the means recommended according to the invention for controlling, if necessary, the pH of the aqueous phase comprises employing at least one buffer system and/or addition of at least one base and/or of at least one acid.

Advantageously, the buffer system can be selected from the group comprising phosphate, borate, and carbonate buffers and mixtures thereof.

According to the invention, the oxidizing agent (Ox) should be selected from oxidizing agents that are able to oxidize a hydrazine function to an azo function and may lead to production of an acid.

Preferably, the oxidizing agent (Ox) is selected from the group comprising:
(Ox1) aqueous halogenated oxidizing agents, for example sodium hypobromite (NaOBr) and/or sodium hypochlorite (NaOCl), and/or tert-butyl hypochlorite;
(Ox2) anhydrous halogenated oxidizing agents, for example Cl₂ and/or Br₂ and/or N-bromosuccinimide and/or halogenated (e.g. chlorinated) cyanuric compounds—e.g. trichloroisocyanuric acid—;
(Ox3) all oxidizing agents other than (Ox1) and
(Ox2), for example hydrogen peroxide;
(Ox4) and mixtures thereof.

Oxidizing agents of type (Oxl) are the oxidizing agents of choice according to the invention. They are at the same time oxidizing agents and bases capable of neutralizing, if necessary, the acidity that they are likely to generate through association of their halogen with an H+. These oxidizing agents (Ox1) therefore do not require the application of an additional base.

When the reaction is carried out in the presence of an anhydrous halogenated oxidizing agent (Ox2), conversion of the hydrazo function (NH—NH) to azo (N═N) is accompanied by the release of one or two acid equivalents (e.g. HCl or HBr).

In these conditions, control of pH to keep it within the desired range requires, according to the invention, adopting at least one of the following operating procedures (among others):

a. use a buffered aqueous phase of the desired pH and add an amount of base (B^{o}) at the same time as the oxidizing agent (Ox2) in order to neutralize the acid released by the reaction;
b. and/or use an unbuffered aqueous phase and add a base (B¹) selecting its nature and amount so as to form a buffer solution of suitable pH during the reaction.

In procedure a., the base B^{o} is, preferably, poured in at roughly the same time as the oxidizing agent (Ox2), and preferably progressively.

In practice, for example, (B^{o}) and (Ox) are added simultaneously, in small amounts (e.g. dropwise) and very slowly (a few minutes to several hours, e.g. in 0.5-2 h) to the reaction mixture.

According to a preferred embodiment, the oxidizing agent(s) (Ox) is/are used in stoichiometric amounts relative to precursor (II).

According to a practical arrangement that can be recommended, the reaction is then carried out in the reaction mixture, preferably stirred and at room temperature, for several hours (e.g. 2-4 h) after completion of addition of the oxidizing agent (Ox).

The organic phase is then separated, dried and then filtered before being concentrated e.g. at reduced pressure.

According to another preferred embodiment, the base (B^{o}) or (B¹) is used in stoichiometric proportions relative to the amount of acid released by the reaction.

Base (B^{o}) or base (B¹) is preferably selected from inorganic bases, preferably from the group comprising: carbonates, phosphates (e.g. K₂HPO₄), borates, soda and mixtures thereof.

According to an optional but nevertheless interesting arrangement of the invention, the reaction mixture comprises at least one organic additive (A), preferably selected from the organic bases, even more preferably from the nitrogen-containing bases and even more preferably from those whose pKₐ is less than the pH of the aqueous phase.

These additives (A), which can notably have the function of further improving the quality of the final product, can be introduced in the reaction mixture.

These additives (A) are advantageously organic compounds.

Even more preferably, said organic additive (A) is selected from organic bases, even more preferably from nitrogen-containing bases and even more preferably from those whose pKₐ is less than the pH of the aqueous phase.

For example, pyridine with pKₐ of 5 can be selected advantageously in the case when an aqueous phase of pH ≈7 is used.

As a nonlimiting illustration, additive (A) is more especially selected from the group comprising: pyridine, quinoline, derivatives of the nicotinate or isonicotinate type and mixtures thereof.

In quantitative terms, additive (A) is preferably present at a molar ratio (A)/(II) between 1.10⁻⁴ and 2, preferably between 1.10⁻² and 1.0.

Said possible addition of additive(s) (A) in the reaction mixture may be envisaged whatever the oxidizing agent: Ox1, Ox2, Ox3 or Ox4. However, when using one or more oxidizing agents Ox1 (e.g. Javel water), it is also particularly beneficial to add a catalytic amount of at least one auxiliary, preferably selected from alkaline salts, alkaline bromides being more especially preferred.

It will then be appropriate, according to the invention, to use the auxiliary at a rate such that the ratio (A)/auxiliary is between 0.1 and 2.0 and is preferably roughly equal to 1.

The method according to the invention for preparing organosilicon compounds with an azo group (I), can be incorporated in a method of synthesis comprising at least the following stages:
(i): react a precursor silane of formula (IV):

[(G⁰)₃SiO_{1/2}]ₘ[(G⁰)₂SiO_{2/2}]ₙ[G⁰SiO_{3/2}]ₒ[SiO_{4/2}]ₚ[(G²)ₐ(G¹)_{a′}L¹SiO_{(3-a-a′)/2}]_{q} (IV)

with a precursor hydrazo derivative of formula (V):

L²—NH—NH—CO-A (V)

formulas in which the symbols G⁰, G¹, G², m, n, o, p, q, a, a′ and A are as defined previously, and L¹ and L² represent groups whose structure and functionality are such that these groups are able to react with one another to give rise to the central linkage -Z-CO— so as to lead to the precursor of formula (II):

(G⁰)₃SiO_{1/2}]ₘ[(G⁰)₂SiO_{2/2}]ₙ[G⁰SiO_{3/2}]ₒ[SiO_{4/2}]ₚ[(G²)ₐ(G¹)_{a′}(Z-CO—HN—NH—CO-A)SiO_{(3-a-a′)/2}]_{q} (II)
(ii): submit the precursor of formula (II) to a reaction of oxidation of the hydrazo group —HN—NH— to an azo group —N═N—.

The oxidation in stage (ii) corresponds to the method of preparation according to the present invention.

For the preparation, for example, of organosilicon compounds with an azo group (I), in the structure of which the symbol Z then represents the divalent radical —(CH₂)₃—NH—, the following synthesis scheme can be applied:
(i): react a precursor silane of formula (IV):

[(G⁰)₃SiO_{1/2}]ₘ[(G⁰)₂SiO_{2/2}]ₙ[G⁰SiO_{3/2}]ₒ[SiO_{4/2}]ₚ(G²)ₐ(G¹)_{a′}SiO_{(3-a-a′)/2}L¹-(CH₂)₃—NCO]_{q} (IV)

with a precursor hydrazo derivative of formula (V):

H₂N—NH—CO-A (V)

to obtain the hydrazo compound of formula (II):

[(G⁰)₃SiO_{1/2}]ₘ[(G⁰)₂SiO_{2/2}]ₙ[G⁰SiO_{3/2}]ₒ[SiO_{4/2}]ₚ[(G²)ₐ(G¹)_{a′}SiO_{(3-a-a′)/2}—(CH₂)₃—NH—CO—NH—NH—CO-A (II)
(ii): submit the compound of formula (II) to a reaction of oxidation of the hydrazo group —HN—NH— to an azo group —N═N—.

To summarize, stage (i) of obtaining precursor (II) and stage (ii) of oxidation of (II) to (I) comply with the following general methodology:

### Stage (i):

Use of a precursor hydrazo derivative of formula (V) and solvent, at the ambient temperature in the reactor, under an inert atmosphere.
Stirring at several hundred rev/min and heating at T=40-100° C.
Addition of the precursor silane of formula (IV) in several tens of minutes.
Reaction for several hours with stirring at T=40-100° C. before returning to room temperature.
Rest for a few hours at room temperature.
Recovery of the solid (for example) precursor of formula (II), filtration, washing, drying.

### Stage (ii):

Use of precursor (II), of the organic solvent, of the aqueous buffer and/or of water and/or of additive (A) at the ambient temperature in the reactor, under an inert atmosphere.
Addition of the oxidizing agent (Ox) and of (B^{o}), (B¹) to the reactor simultaneously, in small amounts (e.g. dropwise) and very slowly (a few minutes to several hours, for example in 0.5 to 2 hours), at a temperature below 30° C., preferably at room temperature.
Stirring at room temperature for several hours.
Extraction of the aqueous phase and collection of the organic phase.
Separation of the organic phase.
Optionally drying.
Optionally filtration.
Concentration.
Recovery of the organosilicon compound with activated azo group (I).

It should be noted that before extracting the aqueous phase, the two-phase reaction mixture of the method according to the invention may for example be in the form of an emulsion of organic phase in the aqueous phase. The organosilicon compound with activated azo group (I) obtained is advantageously contained essentially, or even exclusively, in the organic phase.

According to a particular embodiment, permitting optimization of the purity of the organosilicon final product (I), a post-treatment in one or more stages is proposed, enabling the quality of the final product (I) to be improved significantly, by contributing to the complete or almost complete removal of residues, without affecting the yield and/or productivity with respect to final product (I).

This post-treatment of purification comprises recovering the organosilicon compounds of formula (I) obtained, said recovery comprising at least one separation of the organic phase, optionally at least one filtration and/or at least one concentration of the separated organic phase.

Even more preferably, the post-treatment essentially comprises:
a) mixing a substrate with ionic affinity, preferably carbon black, with an organic solution of filler, at a rate of 0.1 to 20 wt. %, preferably at a rate of 1 to 10 wt. % of substrate with ionic affinity relative to the filler,
b) leaving in contact preferably with stirring for a few minutes to several hours,
c) separating the substrate laden with impurities from the solution of filler, preferably by filtration,
d) removing the solvent preferably by evaporation,
e) mixing a substrate with chemical affinity, preferably a resin of an acid nature (advantageously a slightly acid resin of type IR50), with an organic solution of the filler, at a rate of 0.01 to 10 wt. %, preferably at a rate of 0.1 to 5 wt. % of substrate with chemical affinity relative to the filler,
f) leaving in contact, preferably with stirring, for a few minutes to several hours,
g) separating the substrate laden with impurities from the solution of filler, preferably by filtration,
h) removing the solvent preferably by evaporation, and stages e) to h) can optionally be carried out before stages a) to d) or simultaneously.

In fact, stages a) to d) constitute a first treatment and stages e) to h) a second treatment, and these two treatments can be employed successively in any order or simultaneously.

Moreover, it is possible for the post-treatment employed in the method according to the invention to include only one of these two treatments a) to d), on the one hand, and e) to h), on the other hand.

In addition to the general operating conditions described above, we should dwell a little longer on the organosilicon compounds (I) with activated azo functional group(s) (I), obtained or that can be obtained by said method according to the invention.

As pointed out above, said compounds (I) are free or almost free (undetectable traces) of impurities, notably of pyridine residues. The invention therefore relates to, as novel products, organosilicon compounds (I) with activated azo functional group(s) (I), which can be obtained by the method according to the invention, characterized in that they are free or almost free (undetectable traces) of impurities, notably of pyridine residues.

Said organosilicon compounds (I) with activated azo functional group(s) (I), which can be obtained by the method according to the invention, are also characterized in that they are stable when heated e.g. at temperatures between 80-180° C.

The invention also relates to, as novel products, the organosilicon compounds (I) with activated azo functional group(s) (I) characterized by a degree of hydrolysis/condensation (mol. %) of functions G² less than or equal to 40, preferably to 10, and even more preferably to 1.

Moreover, in the following we shall return again to the meaning of the symbols in formula (I) above.

Firstly, it has to be understood that the group (Z-CO—N═N—CO-A) is joined to the Si atom of the SiO_{(3-a-a′)/2} unit via the divalent radical -Z-.

Moreover, aliphatic hydrocarbon group means, in the sense of the invention, a linear or branched group, preferably comprising from 1 to 25 carbon atoms, optionally substituted.

Advantageously, said aliphatic hydrocarbon group comprises from 1 to 18 carbon atoms, better still from 1 to 8 carbon atoms and even better still from 1 to 6 carbon atoms.

As a saturated aliphatic hydrocarbon group, we may mention the alkyl groups, such as the methyl, ethyl, propyl, isopropyl, n-butyl, isobutyl, t-butyl, pentyl, isopentyl, neopentyl, 2-methylbutyl, 1-ethylpropyl, hexyl, isohexyl, neohexyl, 1-methylpentyl, 3-methylpentyl, 1,1-dimethylbutyl, 1,3-dimethylbutyl, 2-ethylbutyl, 1-methyl-1-ethylpropyl, heptyl, 1-methylhexyl, 1-propylbutyl, 4,4-dimethylpentyl, octyl, 1-methylheptyl, 2-ethylhexyl, 5,5-dimethylhexyl, nonyl, decyl, 1-methylnonyl, 3,7-dimethyloctyl and 7,7-dimethyloctyl, hexadecyl radicals.

The unsaturated aliphatic hydrocarbon groups comprise one or more unsaturations, preferably one, two or three unsaturations of the ethylenic type (double bond) and/or acetylenic type (triple bond).

Examples of them are the alkenyl or alkynyl groups derived from the alkyl groups defined above by elimination of two or more hydrogen atoms. Preferably, the unsaturated aliphatic hydrocarbon groups comprise a single unsaturation.

Within the scope of the invention, carbocyclic group means a monocyclic or polycyclic radical, optionally substituted, preferably of C₃-C₅₀. Advantageously, it is a C₃-C₁₈ radical, preferably mono-, bi- or tricyclic. When the carbocyclic group comprises more than one cyclic nucleus (as in the case of polycyclic carbocycles), the cyclic nuclei are condensed two by two. Two condensed nuclei can be orthocondensed or pericondensed.

The carbocyclic group can comprise, unless stated otherwise, a saturated moiety and/or an aromatic moiety and/or an unsaturated moiety.

Examples of saturated carbocyclic groups are the cycloalkyl groups. Preferably, the cycloalkyl groups are of C₃-C₁₈, and better still of C₅-C₁₀. We may notably mention the cyclopentyl, cyclohexyl, cycloheptyl, cyclooctyl, adamantyl or norbornyl radicals.

The unsaturated carbocycle or any unsaturated moiety of the carbocyclic type has one or more ethylenic unsaturations, preferably one, two or three. It has advantageously from 6 to 50 carbon atoms, and better still from 6 to 20, for example from 6 to 18. Examples of unsaturated carbocycles are the C₆-C₁₀ cycloalkenyl groups.

Examples of aromatic carbocyclic radicals are the (C₆-C₁₈)aryl groups, and better still (C₆-C₁₂)aryl and notably phenyl, naphthyl, anthryl and phenanthryl.

A group having both an aliphatic hydrocarbon moiety as defined above and a carbocyclic moiety as defined above is, for example, an aralkyl group such as benzyl, or an alkaryl group such as tolyl.

The substituents of the aliphatic hydrocarbon groups or moieties and of the carbocyclic groups or moieties are, for example, alkoxy groups in which the alkyl moiety is preferably as defined above.

By hydrolyzable monovalent group, as was discussed above in connection with the symbols G², we mean groups such as, for example: halogen atoms, notably chlorine; the groups —O-G⁷ and —O—CO-G₇ where G₇ represents: a saturated or unsaturated, aliphatic hydrocarbon group, or a saturated, unsaturated and/or aromatic, monocyclic or polycyclic, carbocyclic group, or a group having a saturated or unsaturated, aliphatic hydrocarbon moiety and a carbocyclic moiety as defined above, and G₇ can optionally be halogenated and/or substituted with one or more alkoxy; the groups —O—N═CG₈G₉ in which G₈ and G₉ assume, independently, any one of the meanings given above for G₇, G₈ and G₉ can be halogenated and/or optionally substituted with one or more alkoxy; the groups —O-NG₈G₉ in which G₈ and G₉ are as defined above.

Advantageously, said hydrolyzable monovalent group is a radical: C₁-C₈ alkoxy, linear or branched, optionally halogenated and/or optionally substituted with one or more (C₁-C₈)alkoxy; C₂-C₉ acyloxy optionally halogenated or optionally substituted with one or more (C₁-C₈)alkoxy; C₅-C₁₀ cycloalkyloxy; or C₆-C₁₈ aryloxy. As an example, the hydrolyzable group is methoxy, ethoxy, n-propoxy, isopropoxy, n-butoxy, methoxymethoxy, ethoxyethoxy, methoxyethoxy, β-chloropropoxy or β-chloroethoxy or alternatively acetoxy.

As monovalent carbocyclic groups that can be formed together, in formula (I), by two substituents G² and the silicon atom to which they are attached, we may mention for example the ring systems:

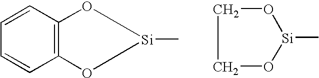

As single rings that can be formed together on the one hand by the substituents G³ and G⁴ of the nitrogen atom present in symbol A of formula (I) and on the other hand by the substituents R² and R³ of the nitrogen atom present in symbol J of formula (III), we may mention for example the following rings where the free valence is carried by a nitrogen atom: pyrrole, imidazole, pyrazole, pyrrolidine, Δ2-pyrroline, imidazolidine, Δ2-imidazoline, pyrazolidine, Δ3-pyrazoline, piperidine; preferred examples are: pyrrole, imidazole and pyrazole.

In preferred forms F1 of formula (I):
The symbols G⁰, which may be identical or different, correspond to the same definition as given hereunder for radicals G¹ or G²;
The symbols G₁, which may be identical or different, each represent: a linear or branched, C₁-C₈ alkyl radical; a C₅-C₁₀ cycloalkyl radical or a C₆-C₁₈ aryl radical;
   The symbols G₂, which may be identical or different, each represent: a linear or branched, C₁-C₈ alkoxy radical, optionally substituted with one or more (C₁-C₈)alkoxy;
   Z represents the divalent radical Z′-Z″- where:
      Z′ represents: a C₁-C₈ alkylene chain; a C₅-C₁₀ saturated cycloalkylene group; a C₆-C₁₈ arylene group; or a divalent group comprising a combination of at least two of these radicals;
      Z″ represents: —O— or —NR⁴—, where R⁴ is: a hydrogen atom; a linear or branched, C₁-C₈ alkyl radical; a C₅-C₁₀ cycloalkyl radical; a C₆-C₁₈ aryl radical; or a (C₆-C₁₈)aryl-(C₁-C₈)alkyl radical;
   A denotes a group —O-G³ or —NG⁴G³ where G³ and G⁴, which may be identical to or different from one another, each represent: a linear or branched, C₁-C₈ alkyl radical; a C₅-C₁₀ cycloalkyl radical or a C₆-C₁₈ aryl radical.

In more preferred forms F2 of formula (I):
The symbols G⁰, which may be identical or different, correspond to the same definition as that given hereunder for the radicals G¹ or G²;
The symbols G₁, which may be identical or different, are selected from the group comprising the methyl, ethyl, propyl, isopropyl, cyclohexyl and phenyl radicals;
The symbols G₂, which may be identical or different, are selected from the group comprising the methoxy, ethoxy, n-propoxy, isopropoxy, n-butoxy, methoxymethoxy, ethoxyethoxy and methoxyethoxy radicals;
Z represents the divalent radical Z′-Z″- where:
   Z′ represents: a C₁-C₈ alkylene chain;
   Z″ represents: —O— or —NR⁴—, with R⁴ being selected from the group comprising: hydrogen, the methyl, ethyl, propyl, isopropyl, n-butyl, isobutyl, t-butyl, pentyl, hexyl, cyclohexyl, and benzyl radicals;
A denotes a group —O-G³ or —NG⁴G³ where G³ and G⁴, which may be identical to or different from one another, are selected from the group comprising the methyl, ethyl, propyl, isopropyl, cyclohexyl and phenyl radicals.

In even more preferred forms F-3 of formula (I):
The symbols G⁰, which may be identical or different, each represent one of the radicals selected hereunder for G¹ or G²;
The symbols G₁, which may be identical or different, are selected from the group comprising the methyl, ethyl, propyl, isopropyl, cyclohexyl and phenyl radicals;
The symbols G₂, which may be identical or different, are selected from the group comprising the methoxy, ethoxy, n-propoxy, isopropoxy and n-butoxy radicals;
Z represents the divalent radical Z′-Z″- where:
   Z′ is selected from the group comprising the methylene, ethylene and propylene divalent radicals;
   Z″ represents: —O— or —NR⁴— with R⁴ being a hydrogen atom;
A denotes a group —O-G³ where G³ is selected from the group comprising the methyl, ethyl, propyl, isopropyl, cyclohexyl and phenyl radicals.

According to an especially preferred embodiment, the functionalized organosilicon compounds of general formula (I) are selected from the group comprising the following species:
(i) functionalized organosilanes corresponding to formula (I) in which: a+a′=3; m=n=o=p=0 (zero); and q=1;
(2i) functionalized siloxane oligomers corresponding to formula (I) in which: a+a′=1 or 2; m is in the range from 1 to 2; n=p=o=0 (zero); and q=1;
(3i) mixtures of at least one species (i) and/or of at least one species (2i).

The siloxane oligomers (2i) constitute a subgroup of compounds of formula (I). This subgroup is derived from a group of compounds of formula (I) corresponding to condition -(C1)- of the method according to the invention, namely when a=0, then:
either at least one of m, n, o, p is a number different from 0 (zero) and q is greater than or equal to 1;
or q is greater than 1 and each of m, n, o, p has any value,
and at least one of the symbols G⁰ corresponds to the definition given hereunder for G².

To obtain said compounds (I) complying with condition -(C1)-, it is appropriate to employ an additional reagent (III) during the corresponding oxidation.

The amount of additional reagent (III) employed is not critical, but it is preferable, according to the invention, for this amount, relative to precursor (II), to be at least 0.1 M, preferably from at least 1 M up to 100 M or more and, even more preferably, should be between 1 and 10 M.

An example of additional reagent (III) is trimethylethoxysilane.

Advantageously, species (2i) are subdivided into subspecies:
(2i.1) functionalized siloxane oligomers corresponding to formula (I) in which: a+a′=2; m=1; n=p=o=0 (zero); and q=1;
(2i.2) functionalized siloxane oligomers corresponding to formula (I) in which: a+a′=1; m=2; n=p=o=0 (zero); and q=1.

According to an interesting variant of the especially preferred embodiment, the functionalized organosilicon compounds of general formula (I) are selected from the group of the following (sub)species:
(i) functionalized organosilanes corresponding to formula (I) in which: a+a′=3; m=n=o=p=0 (zero); and q=1;
(2i.1) functionalized siloxane oligomers corresponding to formula (I) in which: a+a′=2; m=1; n=p=o=0 (zero); and q=1;
(2i.2) functionalized siloxane oligomers corresponding to formula (I) in which: a+a′=1; m=2; n=p=o=0 (zero); and q=1;
(3i) mixtures of at least one species (i) and/or of at least one subspecies (2i.1) and/or of at least one subspecies (2i.2).

Within this variant, functionalized organosilicon compounds of general formula (I) that are particularly preferred are those formed by a mixture (31) of at least one species (i) and/or of at least one subspecies (2i.1) and/or of at least one subspecies (2i.2).

In practice, it is possible for the organosilicon compounds according to the invention to comprise at least one mixture (3i) including compounds (i) and/or (2i.1) and/or (2i.2) of formula (I) in which:
the symbols G⁰, which may be identical or different, correspond to the definitions given below for G¹, G²;
the symbols G₁, which may be identical or different, are selected from the group comprising the methyl, ethyl, propyl, isopropyl, cyclohexyl and phenyl radicals;
the symbols G₂, which may be identical or different, are selected from the group comprising the methoxy, ethoxy, n-propoxy, isopropoxy and n-butoxy radicals;
A denotes a group —O-G³ where G³ is selected from the group comprising the methyl, ethyl, propyl, isopropyl, cyclohexyl and phenyl radicals.
Z represents the divalent radical Z′-NR⁴— where:
   Z′ is selected from the group comprising the methylene, ethylene and propylene divalent radicals;
   R⁴ is a hydrogen atom.

The invention also relates to organosilicon compounds of general formula (I), which can be obtained by the method according to the invention, taken in themselves and selected from the group comprising the following species:
(i) functionalized organosilanes corresponding to formula (I) in which: a+a′=3; m=n=o=p=0 (zero); and q=1, apart from, in the case when the species (i) are used on their own, the organosilicon compounds of formula (I*), (II*) or (III*) as defined above;
(2i) functionalized siloxane oligomers corresponding to formula (I) in which: a+a′=1 or 2; m is in the range from 1 to 2; n=p=o=0 (zero); and q=1;
(3i) mixtures of at least one species (i) and/or of at least one species (2i).

If no additional reagent (III) is used, the compounds produced are silanes of the species (i), or in other words those corresponding to the following formula (I′):

(G²)ₐ(G¹)_{a′}(Z-CO—N═N—CO-A)SiO_{(3-a-a′)/2} (I′)

in which

a represents an integer selected from 1, 2 and 3;

a′ represents an integer selected from 0, 1 and 2;

a+a′=3;

the symbols G₁, G₂, Z and A correspond to the same definitions as were given above for the preferred forms F1, F2 or F3.

Even more preferably, the silanes of formula (I) in which a represents an integer equal to 3 and the symbols G₁, G₂, Z and A correspond to the same definitions as those given above for the preferred form F3.

As examples of silanes (i) of formula (I′) that are especially suitable, we may notably mention the species of type (i) where a=3, a′=0, m=n=o=p=0 and q=1, of formulas:

(C₂H₅O)₃Si—(CH₂)₃—NH—CO—N═N—COOC₂H₅ (iₐ)

(C₂H₅O)₃Si—(CH₂)₃—NH—CO—N═N—COOCH₃ (i_{b})

(CH₃O)₃Si—(CH₂)₃—NH—CO—N═N—COOC₂H₅ (i_{c})

(n-C₄H₉O)₃Si—(CH₂)₃—NH—CO—N═N—COOC₂H₅ (i_{d})

(C₂H₅O)₂(Me₃SiO)Si—(CH₂)₃—NH—CO—N═N—COOC₂H₅ (iₑ)

(C₂H₅O)₂(Me₃SiO)Si—(CH₂)₃—NH—CO—N═N—COOCH₃ (i_{f})

(CH₃O)₂(Me₃SiO)Si—(CH₂)₃—NH—CO—N═N—COOC₂H₅ (i_{g})

(n-C₄H₉O)₂(Me₃SiO)Si—(CH₂)₃—NH—CO—N═N—COOC₂H₅ (iₕ)

The invention will be better understood and its advantages will be seen more clearly from the examples given below, which illustrate the scope and the advantages of the method and of the novel products defined above.

The following examples illustrate the scope of the method presented above.

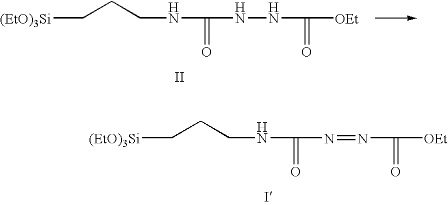

### EXAMPLE 1

In a 100-mL reactor, dissolve 10 g (28.4 mmol) of compound (II) (hydrazo derivative of formula II) in 20 mL of dichloromethane (organic phase). Add 10 g of a buffer solution of pH 7 (phosphate buffer) to the reactor, and start the stirrer. Add, dropwise, a solution of bromine (4.55 g or 28.4 mmol) of Br₂ (Ox2) in 27 mL of CH₂Cl₂ (organic phase) and a solution of potassium hydrogen phosphate (19.85 g of K₂HPO₄—base B^{o}—in 28.5 mL of water) simultaneously in 1 hour. Continue stirring the reaction mixture at room temperature for 3 hours after the end of addition of the bromine (Ox2).

Separate the organic phase, dry over MgSO₄, filter and then concentrate at reduced pressure.

1.38 g of a very viscous orange compound is recovered. Analysis by ¹H-NMR shows that compound (II) has been consumed completely, that the azo function has been formed selectively and that about 35% of the SiOEt functions of compound (I′) have been hydrolyzed and partially condensed.

### EXAMPLE 2

In a '100-mL reactor, dissolve 10 g (28.4 mmol) of compound (II) (hydrazo derivative of formula II) in 20 mL of dichloromethane (organic phase). Add 4 g of a buffer solution of pH 7 (phosphate buffer) and 2.25 g (28.4 mmol) of pyridine (additive A) to the reactor, and start the stirrer. Add, dropwise, a solution of bromine (4.55 g or 28.4 mmol) of Br₂ (Ox2) in 27 mL of CH₂Cl₂—organic phase—and a solution of potassium hydrogen phosphate (19.85 g of K₂HPO₄—base B^{o}—in 28.5 mL of water) simultaneously in 1 hour. Continue stirring the reaction mixture at room temperature for 1 hour after the end of addition of the bromine (Ox2).

Separate the organic phase, dry over MgSO₄, filter and then concentrate at reduced pressure.

8.3 g of an orange liquid is recovered. Analysis by ¹H-NMR shows that compound (II) has been consumed completely and that the azo function has been formed selectively without loss of SiOEt function. Compound (I′) was not isolated but the estimated yield is close to 65%.

### EXAMPLE 3

Carry out the procedure of example 2 but using only 113 mg (1.42 mmol) of pyridine instead of 2.25 g.

In these conditions, 4.9 g of an orange liquid is recovered. Analysis by ¹H-NMR shows that the liquid recovered is composed exclusively of compound (I′) (no pyridine signal can be detected). The yield is 49.5%.

### EXAMPLE 4

In a 100-mL reactor, dissolve 10 g (28.4 mmol) of compound (II) (hydrazo derivative of formula II) in 20 mL of toluene (organic phase). Add 20 g of distilled water and 113 mg (1.42 mmol) of pyridine (additive A) to the reactor, and start the stirrer. Add, dropwise, a solution of bromine (4.55 g or 28.4 mmol of Br₂ (Ox2) in 27 mL of CH₂Cl₂) and a solution of potassium hydrogen phosphate (19.85 g of K₂HPO₄—base B^{o}—in 28.5 mL of water) simultaneously in 1 hour. Continue stirring the reaction mixture at room temperature for 1 hour after the end of addition of the bromine (Ox2).

Separate the organic phase, dry over MgSO₄, filter and then concentrate at reduced pressure.

In these conditions, 5.6 g of an orange liquid is recovered. Analysis by ¹H-NMR shows that the liquid recovered is composed exclusively of compound (I′) (no pyridine signal can be detected). The yield is 57%.

### EXAMPLE 5

In a 100-mL reactor, dissolve 15 g (42.6 mmol) of compound (II) (hydrazo derivative of formula II) in 30 mL of toluene (organic phase). Add 6 g of a buffer solution of pH 5 and 169 mg (2.13 mmol) of pyridine (additive A) to the reactor, and start the stirrer. Add, dropwise, 37.5 g of a solution of Javel water (Ox1) with 12.1 wt. % of active chlorine in 1.5 h. Continue stirring the reaction mixture at room temperature for 3 h after the end of addition of the Javel water (Ox1).

Separate the organic phase. Extract the aqueous phase with 2×20 mL of toluene. Combine the organic phases, dry over MgSO₄, filter and then concentrate at reduced pressure.

11.7 g of a completely odorless orange liquid is recovered. Analysis by ¹H-NMR shows that the conversion of compound (II) is practically total and that the azo function has been formed selectively without loss of SiOEt function. The final mixture contains 100 mol. % of compound (I′). There are no detectable pyridine residues. The yield of isolated compound (I′) is equal to 73%.

### EXAMPLE 6

In a 1-liter reactor, dissolve 100 g (284.5 mmol) of compound (II) (hydrazo derivative of formula II) in 185 mL of toluene (organic phase). Add 80 g of a buffer solution of pH 5, 1.13 g (14.2 mmol) of pyridine (additive A) and 1.46 g of sodium bromide (14.2 mmol) (additive A) to the reactor, and start the stirrer. Add, dropwise, 193 g of a solution of Javel water (Ox1) with 12.1 wt. % of active chlorine in 2 h. Continue stirring the reaction mixture at room temperature for 10 minutes after the end of addition of the Javel water (Ox1).

Separate the organic phase. Extract the aqueous phase with 2×60 mL of toluene. Combine the organic phases, dry over MgSO₄, filter and then concentrate at reduced pressure.

89.5 g of a completely odorless orange liquid is recovered. Analysis by ¹H-NMR shows that the conversion of compound (II) is total and that the azo function has been formed selectively without loss of SiOEt function. The final mixture contains 100 mol. % of compound (I′) There are no detectable pyridine residues. The yield of isolated compound (I′) is equal to 89%.

### EXAMPLE 7

In a 250-mL reactor, dissolve 30 g (85.2 mmol) of compound (II) (hydrazo derivative of formula II) in 60 mL of toluene (organic phase). Add 24 g of a buffer solution of pH 5, 0.07 g (8.52 mmol) of pyridine and 0.09 g of sodium bromide (8.52 mmol) (additive A) to the reactor, and start the stirrer. Add, dropwise, 62.5 g of a solution of Javel water (Ox1) with 12.1 wt. % of active chlorine in 6 h. Continue stirring the reaction mixture at room temperature for 10 minutes after the end of addition of the Javel water (Ox1).

Separate the organic phase. Extract the aqueous phase with 2×0.20 mL of toluene. Combine the organic phases, dry over MgSO₄, filter and then concentrate at reduced pressure.

22.1 g of a completely odorless orange liquid is recovered. Analysis by ¹H-NMR shows that the conversion of compound (II) is total and that the azo function has been formed selectively without loss of SiOEt function. The final mixture contains 100 mol. % of compound (I′). There are no detectable pyridine residues. The yield of isolated compound (I′) is equal to 73.3%.

1.-23. (canceled)

24. A process for the preparation of at least one organosilicon compound having the formula (I) below:
[(G⁰)₃SiO_{1/2}]ₘ[(G⁰)₂SiO_{2/2}]ₙ[G⁰SiO_{3/2}]ₒ[SiO_{4/2}]ₚ[(G²)ₐ(G¹)_{a′}(Z-CO—N═N—CO-A)SiO_{(3-a-a′)/2}]_{q} (I)
in which:
m, n, o, p each represent an integer or fraction greater than or equal to 0;
a represents an integer or fraction greater than or equal to 1;
a represents an integer selected from 0, 1, 2 and 3;
a′ represents an integer selected from 0, 1 and 2;
the sum a+a′ ranges from 0 to 3 under the conditions according to which:
(C1) when a=0, then:
either at least one of m, n, o, p is a number different from 0 (zero) and q is greater than or equal to 1;
or q is greater than 1 and each of m, n, o, p has any value;
and at least one of the symbols G⁰ has the definition given below for G²; and
(C2) when a+a′=3, then m=n=o=0(zero);
the symbols G⁰, which may be identical or different, each represent one of the groups G² or G¹;
the symbols G², which may be identical or different, each represent a hydroxyl group, a hydrolyzable monovalent group or two groups G² may together form, and with the silicon from to which they depend, a ring having 3 to 5 hydrocarbon ring members and which can contain at least one heteroatom, and at least one of these ring members can also be a ring member of at least one other hydrocarbon or aromatic ring;
the symbols G¹, which may be identical or different, each represent a saturated or unsaturated aliphatic hydrocarbon group; a saturated or unsaturated and/or aromatic, monocyclic or polycyclic, carbocyclic group; or a group representing a saturated or unsaturated, aliphatic hydrocarbon moiety and a carbocyclic moiety as defined above;
the symbol Z represents a divalent radical selected from a saturated or unsaturated aliphatic hydrocarbon group; a saturated, unsaturated and/or aromatic, monocyclic or polycyclic, carbocyclic group; and a group having a saturated or unsaturated, aliphatic hydrocarbon moiety and a carbocyclic moiety as defined above; said divalent radical being optionally substituted or interrupted by an oxygen atom and/or a sulfur atom and/or a nitrogen atom, said nitrogen atom, if present, bearing 1 monovalent group selected from a hydrogen atom; an aliphatic, saturated or unsaturated hydrocarbon atom; a saturated or unsaturated and/or aromatic, monocyclic or polycyclic, carbocyclic group; and a group having a saturated or unsaturated, aliphatic hydrocarbon moiety and a carbocyclic moiety as defined above;
the symbol A represents:
a saturated or unsaturated aliphatic hydrocarbon group; a saturated or unsaturated and/or aromatic, monocyclic or polycyclic, carbocyclic group; or a group representing a saturated or unsaturated, aliphatic hydrocarbon moiety and a carbocyclic moiety as defined above;
a group —X-G³ wherein X represents —O—, —S— or —NG⁴- wherein G⁴ is as defined above for G¹; G³, identical to or different from G⁴, represents any one of the groups G¹; and the substituents G³ and G⁴ of the group —NG⁴G³ can together form, and with the nitrogen atom from which they depend, a single ring having from 5 to 7 ring members, with the ring containing 3 to 6 carbon atoms, 1 or 2 nitrogen atom(s) and optionally 1 or 2 unsaturated double bond(s);
or, when q=1, a group 1-Z-SiO_{(3-a-a′)/2}(G²)ₐ(G¹)_{a′}][(G⁰)₃SiO_{1/2}]ₘ[(G⁰)₂SiO_{2/2}]ₙ[G⁰SiO_{3/2}]ₒ[SiO_{4/2}]ₚ in which the symbols Z, G¹, G², a, a′ m, n, o, and p are as defined above;
said process comprising:
providing at least one precursor (II) of at least one organosilicon compound (I), said precursor having the following formula (II):
[(G⁰)₃SiO_{1/2}]ₘ[(G⁰)₂SiO_{2/2}]ₙ[G⁰SiO_{3/2}]ₒ[SiO_{4/2}]ₚ[(G²)ₐ(G¹)_{a′}(Z-CO—H N—NH—CO-A)SiO_{(3-a-a′)/2}] (II)
in which the symbols G⁰, G¹, G², Z, A, m, n, o, p, a, a′ and q are as defined above for formula (I),
oxidizing the hydrazino group of precursor (II) to an azo group of the organosilicon compound with activated azo group(s) (I), by means of an oxidizing system which comprises at least one oxidizing agent (Ox) and at least one base (B), and
in the event that condition (C1) exists, employing an additional reagent selected from among the silanes, whether alone or mixed, of formula (III):
(G⁰)₄₋ₚ₁Si(G^{2′})ₚ₁
in which:
the symbols G⁰, which may be identical or different, each represent a saturated or unsaturated aliphatic hydrocarbon group; a saturated or unsaturated and/or aromatic, monocyclic or polycyclic, carbocyclic group; or a group representing a saturated or unsaturated, aliphatic hydrocarbon moiety and a carbocyclic moiety as defined above; or a polysiloxane residue;
the symbols G^{2′}, which may be identical or different, represent a hydrolyzable monovalent group having the same definition as above for the symbols G² described in connection with formula (I);
p1 represents an integer selected from 1 and 2;
and such oxidation being carried out in an aqueous/organic two-phase medium and in such manner that the pH of the aqueous phase ranges from 3 to 11.

25. The process as defined by claim 24, wherein the pH of the aqueous phase is controlled by means of at least one buffer system and/or by adding at least one base and/or at least one acid, said buffer system optionally comprising phosphate, borate, and carbonate buffers and mixtures thereof.

26. The process as defined by claim 24, wherein the oxidizing agent (Ox) is selected from among oxidizing agents capable of oxidizing a hydrazine function to an azo function and comprising:
(Ox1) aqueous halogenated oxidizing agents, sodium hypobromite (NaOBr) and/or sodium hypochlorite (NaOCl), and/or tert-butyl hypochlorite;
(Ox2) anhydrous halogenated oxidizing agents, Cl₂ and/or Br₂ and/or N-bromosuccinimide and/or halogenated cyanuric compounds;
(Ox3) oxidizing agents other than (Ox1) and (Ox2), hydrogen peroxide; and
(Ox4) mixtures thereof.

27. The process method as defined by claim 26, wherein the reaction is carried out in the presence of an anhydrous halogenated oxidizing agent (Ox2) in such manner that conversion of the hydrazo function (NH—NH) to azo (N═N) is accompanied by the release of acid and in that at least one of the following operating procedures exists:
a. a buffered aqueous phase of the desired pH and an amount of base (B^{o}) are added at the same time as the oxidizing agent (Ox2) to neutralize the acid released by the reaction; and/or
b. an unbuffered aqueous phase and a base (B¹) are added, selecting the nature and amount thereof to form a buffer solution of suitable pH during the reaction.

28. The process as defined by claim 26, wherein the oxidizing agent(s) (Ox) is/are employed in stoichiometric amounts relative to precursor (II).

29. The process as defined by claim 27, wherein the base (B^{o}) or (B¹) is employed in stoichiometric proportions relative to the amount of acid released by the reaction.

30. The process as defined by claim 27, wherein the base (B^{o}) or (B¹) is selected from among the inorganic bases, optionally carbonates, phosphates, borates, soda and mixtures thereof.

31. The process as defined by claim 24, wherein the reaction mixture comprises at least one organic additive (A).

32. The process as defined by claim 31, wherein the additive (A) is selected from among pyridine, quinoline, nicotinate or isonicotinate derivatives and mixtures thereof.

33. The process as defined by claim 31, wherein the additive (A) is present in a molar ratio (A)/(II) ranging from 1.10⁻⁴ to 2.

34. The process as defined by claim 26, wherein one or more oxidizing agents Ox1 are employed and in that at least one auxiliary is also added to the reaction mixture, said auxiliary optionally being selected from the alkaline salts, at a rate of a ratio (A)/auxiliary ranging from 0.1 to 2.0.

35. The process as defined by claim 24, wherein the organosilicon compound (I) thus prepared is subjected to a post-treatment of purification.

36. The process as defined by claim 24, wherein the azoalkoxysilanes of formula (I) obtained are recovered, said recovery comprising at least one separation of the organic phase, optionally at least one filtration and/or at least one concentration of the organic phase that was separated.

37. The process as defined by claim 24, wherein formula (I):
the symbols G⁰, which may be identical or different, are as defined below for the radicals G¹ or G²;
the symbols G¹, which may be identical or different, each represent a linear or branched, C₁-C₈ alkyl radical; a C₅-C₁₀ cycloalkyl radical or a C₆-C₁₈ aryl radical;
the symbols G², which may be identical or different, each represent a linear or branched, C₁-C₈ alkoxy radical, optionally substituted with one or more (C₁-C₈)alkoxy;
Z represents the divalent radical Z′-Z″- wherein:
Z′ represents a C₁-C₈ alkylene radical; a C₅-C₁₀ saturated cycloalkylene radical; a C₆-C₁₈ arylene radical; or a divalent group comprising at least two of these radicals;
Z″ represents —O— or —NR⁴—, wherein R⁴ is a hydrogen atom; a linear or branched, C₁-C₈ alkyl radical; a C₅-C₁₀ cycloalkyl radical; a C₆-C₁₈ aryl radical or a (C₆-C₁₈)aryl-(C₁-C₈)alkyl radical;
A is a group —O-G³ or —NG⁴G³ wherein G³ and G⁴, which may be identical or different, each represent a linear or branched, C₁-C₈ alkyl radical; a C₅-C₁₀ cycloalkyl radical or a C₆-C₁₈ aryl radical.

38. The process as defined by claim 24, wherein formula (I):
the symbols G⁰, which may be identical or different, are as defined below for the radicals G¹ or G²;
the symbols G¹, which may be identical or different, are selected from among methyl, ethyl, propyl, isopropyl, cyclohexyl and phenyl radicals;
the symbols G², which may be identical or different, are selected from among methoxy, ethoxy, n-propoxy, isopropoxy, n-butoxy, methoxymethoxy, ethoxyethoxy and methoxyethoxy radicals;
Z represents the divalent radical Z′-Z″-wherein:
Z′ represents a C₁-C₈ alkylene radical;
Z″ represents —O— or —NR⁴—, wherein R⁴ is selected from among hydrogen, the methyl, ethyl, propyl, isopropyl, n-butyl, isobutyl, t-butyl, pentyl, hexyl, cyclohexyl, and benzyl radicals;
A is a group —O-G³ or —NG⁴G³ wherein G³ and G⁴, which may be identical or different, are selected from among methyl, ethyl, propyl, isopropyl, cyclohexyl and phenyl radicals.

39. The process as defined by claim 24, wherein formula (I):
the symbols G⁰, which may be identical or different, are as defined below for G¹ or G²;
the symbols G₁, which may be identical or different, are selected from among methyl, ethyl, propyl, isopropyl, cyclohexyl and phenyl radicals;
the symbols G₂, which may be identical or different, are selected from among methoxy, ethoxy, n-propoxy, isopropoxy and n-butoxy radicals;
Z represents the divalent radical Z′-Z″- wherein:
Z′ is selected from among methylene, ethylene and propylene divalent radicals;
Z″ represents —O— or —NR⁴— wherein R⁴ is a hydrogen atom;
A is a group —O-G³ wherein G³ is selected from among methyl, ethyl, propyl, isopropyl, cyclohexyl and phenyl radicals.

40. The process as defined by claim 24, wherein the functionalized organosilicon compounds of general formula (I) are selected from among the following species:
(i) functionalized organosilanes corresponding to formula (I) in which a+a′=3; m=n=o=p=0 (zero); and q=1;
(2i) functionalized siloxane oligomers corresponding to formula (I) in which a+a′=1 or 2; m ranges from 1 to 2; n=p=o=0 (zero); and q=1;
(3i) mixtures of at least one species (i) and/or of at least one species (2i).

41. The process as defined by claim 24, wherein the functionalized organosilicon compounds of general formula (I) are selected from among the following species:
(i) functionalized organosilanes corresponding to formula (I) in which a+a′=3; m==2=p=0(zero); and q=1;
(2i.1) functionalized siloxane oligomers corresponding to formula (I) in which a+a′=2; m=1; n=p=o=0 (zero); and q=1;
(2i.2) functionalized siloxane oligomers corresponding to formula (I) in which a+a′=1; m=2; n=p=o=0 (zero); and q=1;
(3i) mixtures of at least one species (i) and/or of at least one subspecies (2i.1) and/or of at least one subspecies (2i.2).

42. The process as defined by claim 24, wherein the compounds produced are silanes corresponding to the following formula (I′):
(G²)ₐ(G¹)_{a′}(Z-CO—N═N—CO-A)SiO_{(3-a-a′)/2} (I′)
in which:
a represents an integer selected from 1, 2 and 3;
a′ represents an integer selected from 0, 1 and 2;
a+a′=3;
the symbols G¹, G², Z and A are as defined above.

43. Organosilicon compounds produced by the process as defined by claim 24, having the formula (I):
[(G⁰)₃SiO_{1/2}]ₘ[(G⁰)₂SiO_{2/2}]ₙ[G⁰SiO_{3/2}]ₒ[SiO_{4/2}]ₚ[(G²)ₐ(G¹)_{a′}(Z-CO—N═N—CO-A)_{SiO}_{(3-a-a′)/2}]_{q} (1)
as defined above; such organosilicon compounds being free or essentially free of impurities, notably of pyridine residues.

44. Organosilicon compounds produced by the process as defined by claim 24, comprising the following species:
(i) functionalized organosilanes corresponding to formula (I) in which a+a′=3; m=n=o=p=0(zero); and q=1;
(2i) functionalized siloxane oligomers corresponding to formula (I) in which a+a′=1 or 2; m ranges from 1 to 2; n=p=o=0 (zero); and q=1;
(3i) mixtures of at least one species (i) and/or of at least one species (2i).

45. Organosilicon compounds produced by the process as defined by claim 24, comprising one or more compounds, which may be identical or different, of formula (I):
[(G⁰)₃SiO_{1/2}]ₘ[(G⁰)₂SiO_{2/2}]ₙ[G⁰SiO_{3/2}]ₒ[SiO_{4/2}]ₚ[(G²)ₐ(G¹)_{a′}(Z-CO—N═N—CO-A)SiO_{(3-a-a′)/2}]_{q} (1)
as defined above; such compounds being stable when heated.

46. Organosilicon compounds produced by the process as defined by claim 24, comprising one or more compounds, which may be identical or different, of formula (I):
[(G⁰)₃SiO_{1/2}]ₘ[(G⁰)₂SiO_{2/2}]ₙ[G⁰SiO_{3/2}]ₒ[SiO_{4/2}]ₚ[(G²)ₐ(G¹)_{a′}(Z-CO—N═N—CO-A)SiO_{(3-a-a′)/2}]_{q} (I)
as defined above; such compounds having a degree of hydrolysis/condensation (mol. %) of the functions G² less than or equal to 40.

47. The process as defined by claim 24, wherein the pH of the aqueous phase ranges from 5 to 9.

48. The process as defined by claim 31, said at least one organic additive comprising an organic base.
